(19) United States
(12) Patent Application Publication
(10) Pub. No.: US 2009/0209447 A1
(43) Pub. Date: Aug. 20, 2009

(54) CLEANING COMPOSITIONS

(76) Inventors: Michelle Meek, Gateshead (GB); Philip Frank Souter, Northumberland (GB); Garry Steven Garrett, Fairfield, OH (US); Charles Winston Saunders, Fairfiled, OH (US); Nancy L. Reeder, Cincinnati, OH (US); Brian Xiaoqing Song, Mason, OH (US); Brian Lee Keith, Hamersville, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/367,813

(22) Filed: Feb. 9, 2009

Related U.S. Application Data
(60) Provisional application No. 61/065,928, filed on Feb. 15, 2008.

(51) Int. Cl. C11D 3/386

(52) U.S. Cl. 510/393

(57) ABSTRACT

The present application relates to nil phosphate and nil borate cleaning compositions comprising a protease cleaning system and a wetting agent, and processes for making and using such compositions. Such compositions offer improved enzyme stability in product and a consumer desirable cleaning profile.

### CROSS REFERENCE TO RELATED APPLICATION

This application claims the benefit of priority to U.S. Provisional Application Ser. No. 61/065,928, filed Feb. 15, 2008 which is herein incorporated by reference.

### FIELD OF INVENTION

The present application relates to low or nil phosphate and low or nil borate cleaning compositions comprising a protease cleaning system and a wetting agent, and processes for making and using such compositions.

### BACKGROUND OF THE INVENTION

Increased environmental awareness has resulted in a movement to reduce the use of materials that are derived from and/or employ oil as an energy source. Such materials include: surfactants, polymers, solvents, borates, and builders such as phosphates. Furthermore, there is a desire, due to ever increasing environmental pressures, to reduce the quantity of such materials that are used in products and the quantity of water that is required to use such products—for example, the water required to rinse washed articles. Unfortunately, in the consumer products arena, when the amount of borates, synthetic polymers and/or builders such as phosphates are reduced, desired properties such as cleaning ability, shine, viscosity and metal care are, generally, negatively impacted.

Accordingly, there is a need for products comprising substantially no phosphate and substantially no borate and which maintain, at a minimum, a consumer desirable viscosity, cleaning/shine/metal care profile.

### SUMMARY OF THE INVENTION

The present application relates to nil phosphate and nil borate cleaning compositions comprising a protease and a mass efficient reversible protease inhibitor, and processes for making and using such compositions.

### DETAILED DESCRIPTION OF THE INVENTION

### Definitions

As used herein, the term “cleaning composition” includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners; hair shampoos and hair-rinses; shower gels and foam baths and metal cleaners; as well as cleaning auxiliaries such as laundry additives, bleach additives and “stain-stick” or pre-treat types, substrate-laden products such as dryer added sheets, dry and wetted wipes and pads, nonwoven substrates, and sponges; as well as sprays and mists.

As used herein, “mass efficient reversible protease inhibitors” are protease inhibitors that have a K_{I} of from about 0.00001 mM to about 10 mM, from about 0.0001 mM to about 5 mM, from about 0.005 mM to about 2 mM, or even from about 0.001 mM to about 0.5 mM.

As used herein “encapsulated proteases” are encapsulated proteases having an average particle size of from about 0.05 microns to about 1000 microns, or from about 0.2 microns to about 700 microns or even from about 0.5 microns to about 150 microns. When said encapsulated proteases are in the form of enzyme granulates/prills, said encapsulated proteases typically have particle size of from about 200 microns to about 1000 microns. When said encapsulated proteases are in the form of enzyme microcapsules, said microcapsules typically have a particle size of from about 100 microns to about 0.05 microns, from about 80 microns to about 0.05 microns, or even from about 50 microns to about 0.05 microns.

As used herein “environmentally friendly sequesterants” are sequesterants selected from the group consisting of amino acid-based sequesterants, succinate-based sequesterants, citric acid and salts of thereof.

As used herein “low-wetting nonionic surfactant” are nonionic surfactants having a Ross Miles foam height of less than or equal to 20 mm, less than or equal to 10 mm or even from 10 mm to about 0.1 mm and a Draves wetting time of greater than or equal to 360 seconds or even from 360 seconds to about 10,000 seconds.

As used herein “wetting agents” are compounds that have a Draves wetting time of less than 360 seconds, less than 200 seconds, less than 100 seconds, less than 60 seconds or even less than 60 seconds to about 1 second and a Ross Miles foam height of less than or equal to 20 mm, less than or equal to 10 mm or even from 10 mm to about 0.1 mm.

As used herein the term “foaming nonionic surfactant” refers to nonionic surfactants which have a Ross Miles foam height of greater than 20 mm, greater than 20 mm to about 500 mm or even greater than 20 mm to about 100 mm.

As used herein the term “cloud point” refers to the temperature at which phase separation of a mixture can be seen. The cloud point can be determined by standard methods such as EN1890.

As used herein, the articles including “a” and “an” when used in a claim, are understood to mean one or more of what is claimed or described.

As used herein, the terms “include”, “includes” and “including” are meant to be non-limiting.

The test methods disclosed in the Test Methods Section of the present application should be used to determine the respective values of the parameters of Applicants' inventions.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total cleaning composition weight unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Compositions

In one aspect, a cleaning composition that may comprise:
a.) a protease cleaning system comprising a material selected from the group consisting of:
   (i) a protease and a mass-efficient reversible protease inhibitor;
   (ii) an encapsulated protease;
   (iii) mixtures thereof;
b.) a wetting agent;
c.) a solvent; and
d.) based on total cleaning composition weight, from 0% to about 0.1%, from about 0% to about 0.05%, from 0% to about 0.01% or even from about 0.0001% to about 0.01% phosphate and/or polyphosphate;
e.) based on total cleaning composition weight, from 0% to about 0.1%, from about 0% to about 0.05%, from 0% to about 0.01% or even from about 0.0001% to about 0.01% borate;
f.) based on total cleaning composition weight, from 0% to about 0.1%, from about 0% to about 0.05%, from 0% to about 0.01% or even from about 0.0001% to about 0.01% zeolite;
   the balance of said composition comprising one or more adjunct ingredients, said cleaning composition having a viscosity of from about 10 cps to about 100,000 cps, from about 30 cps to about 50,000 cps, from about 50 cps to about 30,000 cps, or even from about 55 cps to about 20,000 cps is disclosed.

In one aspect, the aforementioned cleaning composition may comprise, based on total cleaning composition weight from 0% to about 0.1%, from about 0% to about 0.05% or from about 0 to 0.01% of a material that is not a wetting agent, said material selected from the group consisting of an anionic surfactant, a cationic surfactant, a foaming nonionic surfactant and mixtures thereof; and from 0% to about 5.0%, from 0% to about 2%, from 0% to about 1 weight %, from 0% to about 0.8%, from 0% to about 0.1% or even from about 0.001% to about 0.05% of a low-wetting nonionic surfactant that is not a wetting agent.

In one aspect of the aforementioned cleaning composition, the wetting agent may comprise a material selected from the group consisting of alkoxylated aliphatic alcohols, having a cloud point of less than about 60° C., and comprising an alkyl chain comprising from about 6 to about 24 carbon atoms and from about 2 to about 50 pendant alkylene oxide units; epoxy capped poly(oxyalkylated) alcohols; and mixtures thereof.

In one aspect, of the aforementioned cleaning composition, said composition may comprise, based on total cleaning composition weight, at least 0.00001%, from about 0.0001% to 1%, from about 0.001% to 0.5%, from about 0.01% to 0.2% protease and at least 0.00001%, from about 0.0002% to about 2%, or even from about 0.002% to 1%, or even from about 0.005% to 0.5% mass-efficient reversible protease inhibitor; and/or at least 0.001%, from about 0.005% to about 25%, from about 0.05% to about 10% or even from about 0.01% to about 2% encapsulated protease; and at least 0.1%, from about 0.3% to about 10%, from about 0.5% to about 2%, for even from about 0.6% to 1.3% of a wetting agent.

In one aspect of the aforementioned cleaning composition, said cleaning composition may have a viscosity of at least 500 cps, from about 1000 cps to about 100,000 cps, from about 5000 cps to about 50,000 cps or even from about 10,000 cps to about 20,000 cps.

In one aspect of the aforementioned cleaning composition, the cleaning composition may comprise a thickener, said thickener may comprise, based on total thickener weight, at least 1%, from about 1% to about 39%, from about 2% to about 28% or even from about 5% to about 19% alcohol moieties. In one aspect of the aforementioned cleaning composition, the thickener may comprise a polysaccharide and/or a polysaccharide derivative, said polysaccharide or a polysaccharide derivative may comprise in one aspect guar, gellan, xanthan gum and mixtures thereof.

In one aspect of the aforementioned cleaning composition, the cleaning composition of may comprise, based on total cleaning composition weight, from about 0.5% to about 10%, from about 0.6% to about 5%, or even from about 1% to about 3%, sodium silicate and xanthan gum, said xanthan gum may be present in said cleaning composition at level such that the weight ratio of sodium silicate to xanthan gum is from about 15:1 to about 1:2, from about 10:1 to about 1:1.5, from about 3:1 to about 1:1 or even from about 2.5:1 to about 1.5:1.

In one aspect of the aforementioned cleaning composition, the protease may be selected from the group consisting of a metalloprotease, a serine proteases and mixtures thereof; and the mass-efficient reversible protease inhibitor may be selected from the group consisting of a peptide aldehyde, galardin, protein hydrolysates, a phenyl boronic acid derivative and mixtures thereof.

In one aspect of the aforementioned cleaning composition, the serine protease may comprise an alkaline serine protease from E.C. class 3.4.21.62; and the phenyl boronic acid derivative may comprise 4-formyl phenyl boronic acid.

In one aspect of the aforementioned cleaning composition, the cleaning composition may comprise one or more enzymes wherein the enzymes are selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, and mixtures thereof.

In one aspect of the aforementioned cleaning composition, the cleaning composition may have a pH of from about 6 to about 11, from about 7 to about 10, or even from about 8.3 to about 9.

In one aspect of the aforementioned cleaning composition, the cleaning composition may comprise, based on total composition weight, at least 0.1%, from about 0.1% to about 40%, from about 0.5% to about 20% or even from about 1% to about 10% of a nanoparticle composition.

In one aspect of the aforementioned cleaning composition, the cleaning composition may comprise a nanoparticle composition that may comprise nanoclays, selected from the group consisting of bentonites, hectorites and mixtures thereof.

In one aspect of the aforementioned cleaning composition, the cleaning composition may comprise, a polymer selected from the group consisting of:
(a) polycarboxylate-based polymers;
(b) sulphonate or sulphonic acid co-polymers;
(c) a polymer having the following formula:
   bis((C₂H₅O)(C₂H₄O)ₙ)(CH₃)—N+—CₓH₂ₓ—N+—(CH₃)-bis((C₂H₅O)(C₂H₄O)ₙ) wherein n is an integer from 20 to 30, and x is an integer from 3 to 8, said polymer optionally being sulphated or sulphonated;
(d) styrene-based co-polymers; and
(e) mixtures thereof.

In one aspect of the aforementioned cleaning composition, the cleaning composition may comprise an enzyme stabilizer component, said enzyme stabilizer component may comprise: inorganic salts selected from the group consisting of calcium salts, magnesium salts and mixtures thereof—including calcium chloride and/or magnesium chloride; carbohydrates selected from the group consisting of oligosaccharides, polysaccharides and mixtures thereof; and mixtures thereof.

In one aspect of the aforementioned cleaning composition, the cleaning composition may comprise, based on total cleaning composition weight, from about 1% to about 30%, from about 2% to about 20% or even from about 3% to about 9% by weight of an environmentally friendly sequesterant.

In one aspect of the aforementioned cleaning composition, the cleaning composition may comprise a metal care component comprising a material selected from the group consisting of a benzatriazole, a metal complex, a metal salt, silicates and mixtures thereof.

In one aspect of the aforementioned cleaning composition, the cleaning composition may comprise a metal care component comprising a material selected from the group consisting of a zinc salt, a tolytriazole, sodium metasilicate and mixtures thereof.

In one aspect, a cleaning composition comprising a metalloprotease, a mass-efficient reversible protease inhibitor; and an adjunct ingredient is disclosed. Such cleaning composition may comprise a mass efficient reversible protease inhibitor that may be selected from the group consisting of galardin, phosphoramidon, bacitracin zinc and mixtures thereof.

In one aspect, an article that may comprise one or more of the cleaning composition of the present invention and a water soluble film is disclosed.

In one aspect of the aforementioned article, the article may comprise one or more fluid cleaning compositions according to the present invention said fluid cleaning compositions may have a viscosity of from about 50 cps to about 1000 cps, said fluid cleaning composition comprising, based on total fluid cleaning composition weight, from about 1% to about 90%, from about 2% to about 10% or even from about 5% to about 8% water.

In one aspect, the cleaning compositions and articles comprising same may have any combination of the parameters and characteristics disclosed in this present specification.

Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, DE102006022216A1 and DE102006022224A1.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, including those derived from Bacillus amyloliquefaciens described in WO 07/044993A2.

In one aspect, the proteases of the current invention are low temperature proteases which include polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference:
68, 87, 99, 101, 103, 104, 118, 128, 129, 130, 167, 170, 194, 205 & 222

Preferably, the mutations are selected from one or more, preferably two or more and more preferably three or more of the following: V68A, S87N, S99D, S101G, S103A, V104N/I, Y167A, R170S, A194P, V2051 and/or M222S.

If compared directly to the enzyme of SEQ ID NO:1, the above sets of mutations correspond to mutations in the following positions:
66, 85, 97, 99, 101, 102, 116, 126, 127, 128, 160, 164, 188, 199 & 216

Preferably, the mutations are selected from one or more, preferably two or more and more preferably three or more of the following versus the enzyme of SEQ ID NO:1:
V66A, S85N, S97D, S99G, S101A, V102N/I, Y161A, R164S, A188P, V199I and/or M216S.

Most preferably the enzyme is selected from the group comprising the below mutations versus SEQ ID NO:1 (mutation numbering is directly versus SEQ ID NO:1, rather than the BPN′ numbering):

(i) G116V+S126L+P127Q+S128A

(ii) G116V+S126N+P127S+S128A+S160D

(iii) G116V+S126L+P127Q+S128A+S160D

(iv) G116V+S126V+P127E+S128K

(v) G116V+S126V+P127M+S160D

(vi) G116V+S126F+P127L+S128T

(vii) G116V+S126L+P127N+S128V

(viii) G116V+S126F+P127Q

(ix) G116V+S126V+P127E+S128K+S160D

(x) G116V+S126R+P127S+S128P

(xi) S126R+P127Q+S128D

(xii) S126C+P127R+S128D

(xiii) S126C+P127R+S128G

(xiv) S99G+V102N

(xv) N74D+N85S+S101A+V102I

(xvi) N85S+V66A+S99G+V102N

Especially preferred proteases are those having mutations (i), (ii), (xv) or (xvi).

Suitable commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, and those sold under the tradename Opticlean® and Optimase® by Solvay Enzymes. Examples of low temperature proteases include Polarzyme™, (Novozymes A/S, Bagsvaerd, Denmark), Properase®, Properase BS®, Excellase®, FN3® and FN4® (Genencor International Inc., Palo Alto, Calif., USA).

Suitable mass efficient reversible protease inhibitors for the inhibition of serine proteases would include derivates of boronic acid, especially phenyl boronic acid and derivatives thereof and peptide aldehydes, including tripeptide aldehydes. Examples of such compounds are disclosed in WO 98/13458 A1, WO 07/113241 A1, and U.S. Pat. No. 5,972,873.

In one aspect of the present invention, the stabilizer may be selected from the group consisting of thiophene-2 boronic acid, thiophene-3 boronic acid, acetamidophenyl boronic acid, benzofuran-2 boronic acid, naphtalene-1 boronic acid, naphtalene-2 boronic acid, 2-fomyl phenyl boronic acid (2-FPBA), 3-FBPA, 4-FPBA, 1-thianthrene boronic acid, 4-dibenzofuran boronic acid, 5-methylthiophene-2boronic, acid, thionaphtrene boronic acid, furan-2 boronic acid, furan-3boronic acid, 4,4biphenyldiboronic acid, 6-hydroxy-2-naphtalene, 4-(methylthio)phenyl boronic acid, 4(trimethylsilyl)phenyl boronic acid, 3-bromothiophene boronic acid, 4-methylthiophene boronic acid, 2-naphtyl boronic acid, 5-bromothiphene boronic acid, 5-chlorothiophene boronic acid, dimethylthiophene boronic acid, 2-bromophenyl boronic acid, 3-chlorophenyl boronic acid, 3-methoxy-2-thiophene, p-methyl-phenylethyl boronic acid, 2-thianthrene boronic acid, di-benzothiophene boronic acid, 4-carboxyphenyl boronic acid, 9-anthryl boronic acid, 3,5dichlorophenyl boronic, acid, diphenyl boronic acidanhydride, o-chlorophenyl boronic acid, p-chlorophenyl boronic acid m-bromophenyl boronic acid, p-bromophenyl boronic acid, p-fluorophenyl boronic acid, p-tolyl boronic acid, o-tolyl boronic acid, octyl boronic acid, 1,3,5trimethylphenyl boronic acid, 3-chloro-4-flourophenyl boronic acid, 3-aminophenyl boronic acid, 3,5-bis-(trifluoromethyl)phenyl boronic acid, 2,4 dichlorophenyl boronic acid, 4-methoxyphenyl boronic acid and mixtures thereof. Further suitable boronic acid derivatives suitable as stabilizers are described in U.S. Pat. No. 4,963,655, U.S. Pat. No. 5,159,060, WO 95/12655, WO 95/29223, WO 92/19707, WO 94/04653, WO 94/04654, U.S. Pat. No. 5,442,100, U.S. Pat. No. 5,488,157 and U.S. Pat. No. 5,472,628.

In one aspect, the mass efficient reversible protease inhibitor may comprise 4-formyl phenyl boronic acid.

In one aspect, the mass efficient reversible protease inhibitor comprises a reversible peptide protease inhibitor. Examples of suitable reversible peptide protease inhibitors and processes for making same may be found in U.S. Pat. No. 6,165,966 and WO 98/13459 A1.

In one aspect, the tripeptide enzyme inhibitor has the following structure:

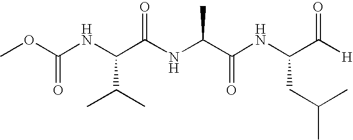

Suitable mass efficient reversible inhibitors for metalloproteases may be selected from the group consisting of:
(i) phosphoramidon and/or peptide isosteric phosphinamides;
(ii) thiols, including, in one aspect, thiorphan, captopril, tiopronine, and/or N-2-mercapto-propionyl glycine);
(iii) zinc specific chelators, including tetraethylene pentamine and/or 1,10-phenanthroline;
(iv) hypoxanthine, 6-methyl6-isopropyl chromone, 3-formyl6-methyl chromone, and/or chloramphenicol;
(v) hydroxamic acids, including, in one aspect, acetohydroxamic, benzohydroxamic, salicylhydroxamic, and/or leucylhydroxamic;
(vi) dipeptide hydroxamic acids, including, in one aspect, hydroxamic acids having a succinyl (dipeptide isostere) motif such as Galardin;
(vii) N-hydroxy urea derivatives, including, in one aspect, dipeptide N-hydroxyl urea derivatives;
(viii) alcohols, carboxyalkylamine peptides, beta-thioester peptides, statins, Batimastat, and/or Marimastat;
(ix) tris(isopropanolamine), hypoxanthine, 3-formyl6-isopropyl chromone, 3-formyl6-methyl chromone, beta-ethyl phenethylalcohol, sulfanilic acid, chloramphenicol, and/or cantharidin;
(x) N-phosphoryl leucinamide, and/or bacitracin zinc;
(xi) Carbamic acid, N-[(phenylmethoxy)carbony]N-hydroxy L-Leucinamide (N-CBZ-Leu-NHOH) and/or N-[(phenylmethoxy)carbony]glyclyl-N-hydroxy L-Leucinamide (N-CBZ-Gly-Leu-NHOH);
(xii) Protein hydrolysates selected from the group comprising wheat gluten hydrolysate (e.g., HyPep 4601™), soy protein acid hydrolysate (e.g., Amisoy), casein acid hydrolysate from bovine milk (e.g., Amicase), enzymic hydrolysate from vegetable protein (e.g., Proteose peptone), and any combination thereof.
(xiii) Protein hydrolysate mixtures selected from the group comprising Albumin hydrolysate; Casein acid hydrolysate vitamin free; Casein Hydrolysate; Casein hydrolysate broth; Casein magnesium broth; Casein yeast magnesium agar; Casein yeast magnesium broth; Edamin® K; Gelatin hydrolysate enzymatic; Gluten Enzymatic Hydrolysate from corn; Hy-Case P; Hy-Case® M; Lactalbumin hydrolysate; Liver Hydrolysate; N-Z-Amine® B; N-Z-Amine® BT; N-Z-Amine® YTT; Peptone; Peptone from casein, acid digest; Peptone from lactalbumin, enzymatic digest, readily soluble; Peptone from meat, peptic digest;

Peptone from milk solids; Peptone from salmon; Peptone Hy-Soy® T; Peptone N-Z-Soy® BL 4; Primatone; Protein Hydrolysate Amicase®; Protein Hydrolysate N-Z-Amine® AS; Proteose Peptone; Soy protein acid hydrolysate; Tryptone; Tryptose; and Vegetable Hydrolysate No. 2; and
(xiv) Mixtures thereof.

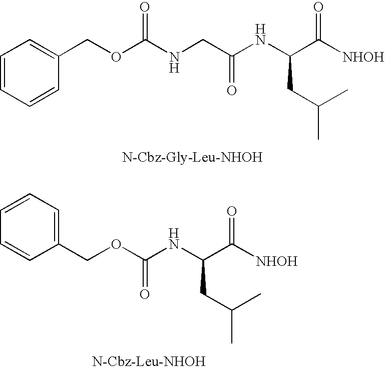

In a further aspect, suitable mass efficient reversible inhibitors can be chosen from those disclosed in EP 0558635 B1 and EP 0558648 B1.

In one aspect, the mass efficient reversible inhibitor may be a hydroxamate derivative, such as galardin, or phosphoramidon or bacitracin zinc. In one aspect the mass efficient reversible inhibitor may be galardin. Commercial sources for such compounds include Sigma Aldrich (Milwaukee, Wis., USA) and Calbiochem (San Diego, Calif., USA). The mono and dipeptide derivatives disclosed herein may be synthesised by the method described in Nishino, Norikazu; Powers, James C. , Biochemistry (1978), 17(14), 2846-50.

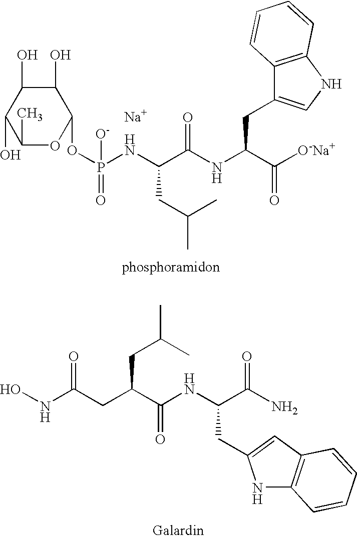

In one aspect, the reversible protease inhibitor is selected from protein hydrolysates that have optionally been produced by enzymatic digestion. In one aspect, said protein hydrolysates have a molecular weight less than about 5000 Da.

In one aspect, the compositions of the present invention comprise, based on total cleaning composition weight, from about 0.0001% to about 4%, or from about 0.0002% to about 2%, or from about 0.002% to about 1%, or even from about 0.005% to about 0.5% mass efficient reversible protease inhibitor.

In one aspect, the 4-formyl phenyl boronic acid and the protease enzyme may be present in liquid cleaning compositions of the present invention at a molar ratio of from about 10:1 to about 500:1, or even from about 30:1 to about 200:1.

In one aspect, in liquid cleaning compositions of the present invention, the molar ratio of the reversible peptide protease inhibitor to protease enzyme may be from about 1:1 to about 20:1, or even from about 1:1 to about 10:1.

Without wishing to be bound by theory, it is believed that an effective mass efficient reversible protease inhibitor needs to bind tightly to the protease within the formulation, but not so tightly that upon dilution in the wash the protease is not effectively released.

Suitable encapsulated proteases may be prepared by methods such as:
(i) interfacial condensation polymerization, including capsules formed by the reaction of acid chlorides with compounds containing at least two amine groups and polycondensation reaction of formaldehyde with melamine. Examples of such methods are disclosed in U.S. Pat. No. 4,906,396, U.S. Pat. No. 6,221,829, U.S. Pat. No. 6,359,031, U.S. Pat. No. 6,242,405 and WO 07/100501 A2.
(ii) sol-gel processes including capsules made by reaction of aminoalkylsilane precursors and aminoalkyl-trialkoxysilane, and one or more alkoxysilane precursors, examples of which are disclosed in WO 05/028603 A1 and WO 05/028604 A1; and
(iii) polyectrolyte precipitation, including capsules formed by reaction of chitosan and alginate or using biopolymer gels such as gellan. Examples of such methods are disclosed in EP 1,502,645 A1.

In one aspect the encapsulated protease may comprise at least 0.5%, or at least 1%, or at least 2%, or at least 5%, or at least 10%, or even at least 20% by weight active protease enzyme.

In one aspect, encapsulated proteases may comprise from about 5% to about 90% active protease by weight.

Encapsulated proteases may be incorporated into the compositions of the present invention, based on total cleaning composition weight, at a level of from 0.001% to about 30%, or from about 0.005% to about 25%, or from about 0.05% to about 10% or even from about 0.01% to about 2%.

Without wishing to be bound by theory, it is believed that having a low particle size facilitates the liquid phase's ability to suspend the particles, thereby keeping the liquid phase as homogenous as possible. When said encapsulated proteases are in the form of enzyme microcapsules, said microcapsules typically have a particle size of from about 100 microns to about 0.05 microns, from about 80 microns to about 0.05 microns, or even from about 50 microns to about 0.05 microns. Thus, in one aspect, such microcapsules are sized such that they are not typically visible to a consumer when such microcapsules are incorporated into a cleaning composition.

In one aspect, the encapsulated protease releases at least 80% of its protease load within 10 minutes, within 5 minutes, or even within 2 minutes upon dilution in the wash. In one aspect, these release rates are achievable at ambient temperatures under a 100 fold dilution at 20° C. with stirring at 150 rpm. Protease activity can be determined by any standard method such as use of protease analysis kits available from Sigma Aldrich, Milwaukee, Wis., USA or ASTM method D0348-89 (2003). Without wishing to be bound by theory, it is believed that a better cleaning profile is obtained as the time that the enzymes have to interact with the soil is increased.

In one aspect, encapsulated proteases may be enzyme granulates/prills, having an average particle size of 200-1000 microns. Such enzyme granules/prills may be made in accordance with the teachings of U.S. Pat. No. 4,106,991, U.S. Pat. No. 4,242,219, U.S. Pat. No. 4,689,297, U.S. Pat. No. 5,324,649 and U.S. Pat. No. 7,018,821 B2. In one aspect, such enzyme granulates/prills may comprise a dye and/or pigment. In one aspect, such enzyme granulates/prills may comprise a coating comprising hydroxpropylmethylcellulose and/or polyvinylalcohol and derivatives thereof.

Suitable wetting agents include alkoxylated aliphatic alcohols, having a cloud point of less than about 60° C., and comprising from about 6 to about 24 carbon atoms and incorporating from about 2 to about 50, or even from about 10 to 50 alkylene oxide moieties. In one aspect, such oxide moieties may be ethylene oxide and/or propylene oxide moieties. Suitable wetting agents include, Plurafac SLF 4030®, Plurafac SLF-18® and Poly-Tergent® SLF18B 45 supplied by BASF Corporation of Ludwigshafen, Germany. Additional suitable wetting agents include epoxy capped poly(oxyalkylated) alcohols described in WO 94/22800.

In one aspect, the cleaning compositions of the present invention may comprise, based on total cleaning composition weight, from about 0.001% to about 15%, or from about 0.1% to about 15%, or from about 0.3% to about 10%, or from about 0.5% to 2% or even from about 0.6% to 1.3% wetting agent.

Solvent—The cleaning compositions of the present invention may comprise a solvent selected from water, alcohols, silicones, glycols, glycerine and mixtures thereof. In one aspect, such cleaning compositions may be gels and the solvent may comprise greater than 80%, greater than 90% or even 100% water. In one aspect, the cleaning compositions of the present invention may be a unit dose that may comprise an encapsulated liquid. Such liquid may comprise material selected from the group consisting of water, dipropylene glycol, glycerine, ethanol and mixtures thereof. In one aspect, said liquid phase of such unit dose may comprise from about 1% to about 90%, from about 2% to about 10% or even from about 5% to about 8% by weight water.

In one aspect, cleaning compositions of the present invention may have a viscosity of from about 10 cps to about 100000 cps, from about 30 cps to about 50,000 cps, from about 50 cps to about 30,000 cps, or even from about 55 cps to about 20,000 cps.

In one aspect, when the cleaning composition is a dual or multi-phase unit dose wherein at least one of the phases is a liquid, the liquid phase of such composition may have a viscosity of from about 10 cps to about 500 cps, from about 30 cps to about 300 cps, from about 50 cps to about 200 cps, or even from about 55 cps to about 180 cps.

In one aspect, the cleaning composition may be a gel and that may have a viscosity of from about 500 cps, or from about 1000 cps to about 100,000 cps, from about 5,000 cps to about 50,000 cps, from about 10,000 cps to about 20,000 cps, or even from about 12,000 cps to about 18,000 cps.

In one aspect, said gel may also comprise a thickener selected from the group of naturally-derived polymeric gums, including, in one aspect, a polysaccharide or a polysaccharide derivative, such as guar, gellan and/or xanthan gums. Conventional detergent formulations may comprise borate/diol systems intended to reversibly inhibit the composition's protease, synthetic polymers, such as polycarboxylates, and high levels of builder such as phosphate to deliver a consumer preferred viscosity.

Without wishing to be bound by theory, it is believed that moving to a naturally derived polymer in a low/nil phosphate formulation, provides the consumer with a more environmentally friendly detergent but confronts the formulator with the dilemma of offering good protease stability (to deliver the consumer desired cleaning) by including borate/diol and leaving out the thickener, or including the thickener and omitting borate thus giving the consumer the desired viscosity profile but less than desired protease stability. The compositions of the present invention resolve the aforementioned dilemma as such compositions provide the consumer with a consumer desirable cleaning profile, a consumer desired viscosity profile and a more environmentally friendly detergent.

### Enzyme Related Terminology

### Nomenclature for Amino Acid Modifications

In describing enzyme variants herein, the following nomenclature is used for ease of reference: Original amino acid(s):position(s):substituted amino acid(s).

According to this nomenclature, for instance the substitution of glutamic acid for glycine in position 195 is shown as G195E. A deletion of glycine in the same position is shown as G195*, and insertion of an additional amino acid residue such as lysine is shown as G195GK. Where a specific enzyme contains a “deletion” in comparison with other enzyme and an insertion is made in such a position this is indicated as *36D for insertion of an aspartic acid in position 36. Multiple mutations are separated by pluses, i.e.: S99G+V102N, representing mutations in positions 99 and 102 substituting serine and valine for glycine and asparagine, respectively. Where the amino acid in a position (e.g. 102) may be substituted by another amino acid selected from a group of amino acids, e.g. the group consisting of N and I, this will be indicated by V102N/I.

In all cases, the accepted IUPAC single letter or triple letter amino acid abbreviation is employed.

### Amino Acid Identity

The relatedness between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of and enzyme used herein (“invention sequence”) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity. An exact match occurs when the “invention sequence” and the “foreign sequence” have identical amino acid residues in the same positions of the overlap. The length of a sequence is the number of amino acid residues in the sequence.

Adjunct Materials

While not essential for the purposes of the present invention, the non-limiting list of adjuncts illustrated hereinafter are suitable for use in the instant compositions and may be desirably incorporated in certain embodiments of the invention, for example to assist or enhance performance, for treatment of the substrate to be cleaned, or to modify the aesthetics of the cleaning composition as is the case with perfumes, colorants, dyes or the like. It is understood that such adjuncts are in addition to the components that are recited in the previous paragraphs detailing the compositions of the present invention. The precise nature of these additional components, and levels of incorporation thereof, will depend on the physical form of the cleaning composition and the nature of the operation for which it is to be used. Suitable adjunct materials include, but are not limited to, polymers, for example cationic polymers, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, perfume and perfume delivery systems, structure elasticizing agents, fabric softeners, carriers, hydrotropes, processing aids and/or pigments. In addition to the disclosure below, suitable examples of such other adjuncts and levels of use are found in U.S. Pat. No. 5,576,282, U.S. Pat. No. 6,306,812 B1 and U.S. Pat. No. 6,326,348 B1.

As stated, the adjunct ingredients are not essential to Applicants' cleaning and fabric care compositions. Thus, certain embodiments of Applicants' compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments. However, when one or more adjuncts are present, such one or more adjuncts may be present as detailed below:

Enzymes—The cleaning compositions can comprise one or more enzymes which provide cleaning performance and/or fabric care benefits. Examples of suitable enzymes include, but are not limited to, hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a cleaning composition, the aforementioned additional enzymes may be present at levels from about 0.00001% to about 2%, from about 0.0001% to about 1% or even from about 0.001% to about 0.5% enzyme protein by weight of the composition.

Suitable alpha-amylases include those of bacterial or fungal origin. Chemically or genetically modified mutants (variants) are included. In one aspect, a suitable alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818), DSM 12368, DSM 12649, KSM AP1378 (WO 97/00324), KSM K36 or KSM K38 (EP 1,022,334). Suitable amylases include:

(a) the variants described in WO 94/02597, WO 94/18314, WO 96/23874 and WO 97/43424, and in one aspect, the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.

(b) the variants described in U.S. Pat. No. 5,856,164 and WO 99/23211, WO 96/23873, WO 00/60060 and WO 06/002643, and in one aspect, the variants with one or more substitutions in the following positions versus the AA560 enzyme listed as SEQ ID No. 12 in WO 06/002643: 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484 that also, in one aspect, may contain the deletions of D183* and G184*.

(c) variants exhibiting at least 90% identity with SEQ ID No. 4 in WO 06/002643, the wild-type enzyme from Bacillus SP722, and in one aspect, variants with deletions in the 183 and 184 positions and variants described in WO 00/60060.

(d) variants derived from Bacillus sp.707, whose sequence is shown as SEQ ID NO:2, preferably comprising one or more of the following mutations M202, M208, S255, R172, and/or M261. Preferably said amylase comprises one or more of M202L, M202V, M202S, M202T, M2021, M202Q, M202W, S255N and/or R172Q. Particularly preferred are those variants comprising the M202L or M202T mutations.

In one aspect, preferred amylases comprise those with a one or more, preferably two or more, more preferably three or more and especially four or more substitutions in the following positions versus the AA560 enzyme listed as SEQ ID No. 12 in WO 06/002643: 9, 26, 149, 182, 186, 202, 257, 295, 299, 323, 339 and 345; and optionally with one or more, preferably four or more and more preferably all of the substitutions and/or deletions in the following positions: 118, 183, 184, 195, 320 and 458, which if present preferably comprise R118K, D183*, G184*, N195F, R320K and/or R458K.

In one aspect, preferred variant amylases include those comprising the following sets of mutations versus the AA560 enzyme listed as SEQ ID No. 12 in WO 06/002643:
(i) M9L+M323T;
(ii) M9L+M202UT/V/I+M323T;
(iii) M9L+N195F+M202UT/V/I+M323T;
(iv) M9L+R118K+D183*+G184*+R320K+M323T+R458K;
(v) M9L+R118K+D183*+G184*+M202UT/V/I+R320K+M323T+R458K;
(vi) M9L+G149A+G182T+G186A+M202L+T257I+Y295F+N299Y+M323T+A339S+E345R;
(vii) M9L+G149A+G182T+G186A+M202I+T257I+Y295F+N299Y+M323T+A339S+E345R;
(viii) M9L+R118K+G149A+G182T+D183*+G184*+G186A+M202L+T257I+Y295F+N299Y+R320K+M323T+A339S+E345R+R458K;
(ix) M9L+R118K+G149A+G182T+D183*+G184*+G186A+M202I+T257I+Y295F+N299Y+R320K+M323T+A339S+E345R+R458K;
(x) M9L+R118K+D183*+D184*+N195F+M202L+R320K+M323T+R458K;
(xi) M9L+R118K+D183*+D184*+N195F+M202T+R320K+M323T+R458K;
(xii) M9L+R118K+D183*+D184*+N195F+M202I+R320K+M323T+R458K;
(xiii) M9L+R118K+D183*+D184*+N195F+M202V+R320K+M323T+R458K;
(xiv) M9L+R118K+N150H+D183*+D184*+N195F+M202L+V214T+R320K+M323T+R458K; or
(xv) M9L+R118K+D183*+D184*+N195F+M202L+V214T+R320K+M323T+E345N+R458K.

Suitable commercially available alpha-amylases include DURAMYL®, LIQUEZYME® TERMAMYL®, TERMAMYL ULTRA®, NATALASE®, SUPRAMYL®, STAINZYME®, STAINZYME PLUS®, STAINZYME ULTRA®, FUNGAMYL®, BIOAMYLASE-D(G), BIOAMYLASE® L and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, OPTISIZE HT PLUS® and PURASTAR OXAM® (Genencor International Inc., Palo Alto, Calif.) and KAM® 14-10 Nihonbashi Kayabacho, 1-chome, Chuo-ku Tokyo 103-8210, Japan. In one aspect, suitable amylases include NATALASE®, STAINZYME® and STAINZYME PLUS® and mixtures thereof.

Enzyme stabilizer components—Suitable enzyme stabilizers include oligosaccharides, polysaccharides and inorganic divalent metal salts, such as alkaline earth metal salts, especially calcium salts. In one aspect, suitable enzyme stabilizers include chlorides and sulphates. In one aspect, a suitable enzyme stabilizer includes calcium chloride. Examples of suitable oligosaccharides and polysaccharides, such as dextrins, can be found in WO 07/145964 A2.

Environmentally friendly sequesterants—Suitable environmentally friendly sequesterants include one or more of amino acid-based sequesterants, succinate-based sequesterants, citric acid and salts thereof.

Examples of suitable amino acid based compounds include MGDA (methyl-glycine-diacetic acid), and salts and derivatives thereof and GLDA (glutamic-N,N-diacetic acid) and salts and derivatives thereof. Other suitable builders are described in U.S. Pat. No. 6,426,229. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl)glutamic acid (SMGL), N-(2-sulfoethyl)glutamic acid (SEGL), N-methyliminodiacetic acid (MIDA), -alanine-N,N-diacetic acid (-ALDA), serine-N,N-diacetic acid (SEDA), isoserine-N,N-diacetic acid (ISDA), phenylalanine-N,N-diacetic acid (PHDA) anthranilic acid-N,N-diacetic acid (ANDA), sulfanilic acid-N,N-diacetic acid (SLDA) taurine-N,N-diacetic acid (TUDA) and sulfomethyl-N,N-diacetic acid (SMDA) and alkali metal salts or ammonium salts thereof. In one aspect, GLDA salts and derivatives thereof may be employed. In one aspect, the tetrasodium salt of GLDA may be employed.

Examples of suitable succinate compounds are described in U.S. Pat. No. 5,977,053. In one aspect, suitable succinate compounds include tetrasodium immino succinate.

Performance polymers—Suitable polymers include polycarboxylates, sulphonated polymers, amine-based polymers, styrene co-polymers and mixtures thereof.

In one aspect, polycarboxylate-based polymers include polycarboxylate polymers that may have average molecular weights of from about 500 Da to about 500,000 Da, or from about 1,000 Da to about 100,000 Da, or even from about 3,000 Da to about 80,000 Da. In one aspect, suitable polycarboxylates may be selected from the group comprising polymers comprising acrylic acid such as Sokalan PA30, PA20, PA15, PA10 and sokalan CP10 (BASF GmbH, Ludwigshafen, Germany), Acusol™ 45N, 480N, 460N and 820 (sold by Rohm and Haas, Philadelphia, Penn., USA) polyacrylic acids, such as Acusol™ 445 and Acusol™ 420 (sold by Rohm and Haas, Philadelphia, Penn., USA) acrylic/maleic co-polymers, such as Acusol™ 425N and acrylic/methacrylic copolymers. Several examples of such polymers are disclosed in WO 95/01416.

In one aspect the sulphonated polymers may be selected from the group comprising Acusol™588 (sold by Rohm and Haas, Philadelphia, Penn., USA), Versaflex Si™ (sold by Alco Chemical, Tenn., USA) and those described in U.S. Pat. No. 5,308,532 and in WO 2005/090541.

In one aspect, the amine-based polymers include compounds having the following general structure: bis((C₂H₅O)(C₂H₄O)ₙ)(CH₃)—N+—CₓH₂ₓ—N+—(CH₃)-bis((C₂H₅O)(C₂H₄O)ₙ), wherein n=from 20 to 30, and x=from 3 to 8, or sulphated or sulphonated variants thereof.

In one aspect, the styrene co-polymers may be selected from the group comprising, styrene co-polymers with acrylic acid and optionally sulphonate groups, having average molecular weights in the range 1,000-50,000, or even 2,000-10,000 such as those supplied by Alco Chemical Tennessee, USA, under the tradenames Alcosperse® 729 and 747.

Without wishing to be bound by theory, the performance polymers may be included to provide benefits in one or more of the areas of spotting and filming, dispersancy, cleaning and beverage stain cleaning.

Suitable low wetting nonionic surfactants include block copolymer surfactants of ethylene oxide and propylene oxide. Suitable examples may have the following chemical structure and properties:

HO(C₂H₄O)ₐ(C₃H₆O)_{b}(C₂H₄O)_{c}H

In one aspect, said low wetting nonionic surfactants can be sourced from the BASF Corporation, Ludwigshafen, Germany under the tradenames Pluronic® 10R5, Pluronic® F127NF and Pluronic®L44NF.

Thickeners—Suitable thickeners, such as thixotropic thickeners, include clays, gums, polymers and gels. Such thickeners may provide a consumer-preferred viscosity and improve stability of a liquid product. Thickeners for use herein include those selected from clay, polycarboxylates, such as Polygel®, gums, carboxymethyl cellulose, polyacrylates, and mixtures thereof. Clay thickeners herein may have a double-layer structure. The clay may be naturally occurring, e.g., Bentonites, or artificially made, e.g., Laponite®. Laponite is supplied by Southern Clay Products, Inc.

In one aspect, the thickeners may comprise, based on total thickener weight, at least 1 weight %, from about 1 weight % to about 39 weight %, from about 2 weight % to about 28 weight % or even from about 5 weight % to about 19 weight % alcohol moieties.

In another aspect, thickeners may be naturally-derived polymeric gums that can be characterized as marine plant, terrestrial plant, microbial polysaccharides and polysaccharide derivatives. Examples of marine plant gums include agar, alginates, carrageenan and furcellaran. Examples of terrestrial plant gums include guar gum, gum arable, gum tragacenth, karaya gum, locust bean gum and pectin. Examples of microbial polysaccharides include dextran, gellan gum, rhamsan gum, welan gum and xanthan gum. Examples of polysaccharide derivatives include carboxymethyl cellulose, methyl hydroxypropyl cellulose, hydroxy propyl cellulose, hydroxyethyl cellulose, propylene glycol alginate and hydroxypropyl guar.

In one aspect, thickeners may include methylcellulose, hydroxypropylmethylcellulose such as Methocel® trade name from Dow Chemical Company, Midland, Mich., USA, xanthan gum, gelIan gum, guar gum and hydroxypropyl guar gum, succinoglycan and trihydroxystearin. Other illustrative examples of structurants include the nonpolymeric hydroxyfunctional structurants, such as, castor oil and its derivatives. Commercially available, castor oil-based, crystalline, hydroxyl-containing structurants include THICIN® from Rheox, Inc, Hightstown, N.J., USA. In one aspect, guar gum, gellan gum and xanthan gum and derivatives thereof, such as those supplied under the tradenames Rhodopol™ 23 (sold by Rhodia, Courbevoie, France), KELCOGEL™ (CP Kelco, Houston, Tex., USA) and the xanthan gum range derived from the bacterium Xanthomonas campestris and sold by Jungbunzlauer International AG, Basel, Switzerland, may be employed.

pH adjusting components—In one aspect, the pH a liquid detergent according to the present invention may be from about 6 to about 11, from about 7 to about 10, or even from about 8.3 to about 9. To achieve the desired pH, pH adjusting components may be used. The pH adjusting components may be selected from sodium or potassium hydroxide, sodium or potassium carbonate or sesquicarbonate, sodium or potassium silicate, including sodium disilicate, sodium metasilicate and crystalline phyllosilicate, sodium or potassium bicarbonate, sulphuric acid, nitric acid, hydrochloric acid and mixtures thereof. In one aspect, the pH adjusting component may comprise at least in part a silicate, such as sodium silicate. Without wishing to be bound by theory it is believed that both the level of silicate in formulation and the ratio of its mass to that of the thickening agent are important to offering a consumer preferred viscosity. In one aspect, the silicate may comprise sodium silicate and such sodium silicate may be present, based on total cleaning composition weight at a level from about 0.5% to about 10%, from about 0.6% to about 5%, or even from about 1% to about 3%, while the structurant may comprise xanthan gum which may be present, based on total cleaning composition weight at a level from about 0.5% to about 2%, or even from about 0.7% to about 1.2%. In a further aspect, the ratio by weight of sodium silicate to xanthan gum may be from about 15:1 to about 1:2, from about 10:1 to about 1:1.5, from about 3:1 to about 1:1, or even from about 2.5:1 to about 1.5:1.

Metal Care agents—This metal care agents may prevent or reduce the tarnishing, corrosion or oxidation of metals, including aluminium, stainless steel and non-ferrous metals, such as silver and copper. Suitable examples include one or more of the following:
(a) benzatriazoles, including benzotriazole or bis-benzotriazole and substituted derivatives thereof. Benzotriazole derivatives are those compounds in which the available substitution sites on the aromatic ring are partially or completely substituted. Suitable substituents include linear or branch-chain C₁-C₂₀-alkyl groups and hydroxyl, thio, phenyl or halogen such as fluorine, chlorine, bromine and iodine.
(b) metal salts and complexes chosen from the group consisting of zinc, manganese, titanium, zirconium, hafnium, vanadium, cobalt, gallium and cerium salts and/or complexes, the metals being in one of the oxidation states II, III, IV, V or VI. In one aspect, suitable metal salts and/or metal complexes may be chosen from the group consisting of Mn(II) sulphate, Mn(II) citrate, Mn(II) stearate, Mn(II) acetylacetonate, K₂TiF₆, K₂ZrF₆, CoSO₄, Co(NO₃)₂ and Ce(NO₃)₃, zinc salts, for example zinc sulphate, hydrozincite or zinc acetate.;
(c) silicates, including sodium or potassium silicate, sodium disilicate, sodium metasilicate, crystalline phyllosilicate and mixtures thereof.

Further suitable organic and inorganic redox-active substances that act as silver/copper corrosion inhibitors are disclosed in WO 94/26860 and WO 94/26859.

In one aspect, one or more of zinc sulphate hexahydrate, tolyltriazole and sodium metaslicate may be employed in the cleaning compositions of the present invention.

Bleaching Agents and Non-metal Bleach Catalysts—The cleaning compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the cleaning compositions of the present invention may comprise from about 0.1% to about 50% or even from about 0.1% to about 25% bleaching agent by weight of the subject cleaning composition. In one aspect, any bleaching agent that is present is in a form whereby it cannot react with the enzymes present in the cleaning composition. This can be achieved for example when the bleach is encapsulated or otherwise physically separated from the enzymes. Examples of suitable bleaching agents include:

(1) preformed peracids: Suitable preformed peracids include, compounds selected from the group consisting of percarboxylic acids and salts, percarbonic acids and salts, perimidic acids and salts, peroxymonosulfuric acids and salts, for example, Oxone®, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen. Examples include perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and optionally, the salts thereof. In one aspect, peroxynonanoic acid and phthalimidoperhexanoic acid (PAP) may be employed.

(2) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts may be selected from the group consisting of sodium salts of perborate, percarbonate and mixtures thereof. When employed, inorganic perhydrate salts may be present in amounts of from 0.05% to 40 wt %, or 1% to 30 wt % of the overall cleaning composition and may be incorporated into such a composition as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and

(3) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups include benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

(4) Suitable non-metal bleach catalysts and appropriate levels of such catalysts for use in the present cleaning compositions are disclosed in U.S. Pat. No. 7,169,744 B2 and USP 2006/0287210 A1.

When present, the peracid and/or bleach activator is generally present, based on total cleaning composition weight, at a level of from about 0.1% to about 60 wt %, from about 0.5% to about 40 wt % or even from about 0.6% to about 10 wt %. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid may be from 1:1 to 35:1, or even 2:1 to 10:1

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Examples of such catalysts are disclosed in U.S. Pat. No. 4,430,243.

If desired, the cleaning compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

The cleaning compositions herein may also suitably include a transition metal complex of ligands such as bispidones (WO 05/042532 A1) and/or macropolycyclic rigid ligands—abbreviated as “MRLs”. As a practical matter, and not by way of limitation, the cleaning compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor. Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464 B1.

Foam control agent—Suitable foam control agents include silicones and paraffin oil. The foam control agents may be present in the cleaning compositions in amounts of 5% or less, or even 2% or less by weight based on total cleaning composition weight.

Nanoparticle composition—Nanoparticle compositions may comprise nanoparticles and optionally a dispersant to prevent said nanoparticles from aggregating.

Examples of suitable nanoparticles are disclosed in EP 1,837,394 A1. In one aspect, nanoparticles may be selected from clays, metal oxides, carbonates and mixtures thereof. In one aspect, nanoparticles may be selected from titanium dioxide, zinc oxide, cerium oxide and mixtures thereof.

In one aspect, nanoparticles selected from the group consisting of clays and metal oxides are employed in the cleaning compositions of the present invention. Nanoclays may be charged crystals having a layered structure. The top and bottom of the crystals are usually negatively charged and the sides may be positively charged. Due to the charged nature of nanoclays, it is believed that they tend to aggregate in solution to form large structures that do not effectively contribute to the cleaning. Moreover, such structures may deposit on the washed load leaving an undesirable film on them. In particular, such nanoclays may tend to aggregate in the presence of calcium and magnesium found in wash water. In one aspect of the invention, a nanoclay is exfoliated in the wash liquor. By “exfoliated” it is meant that the nanoclay is in the form of independent crystals, in particular in the form of individual crystals having a particle size of from about 10 nm to about 300 nm. The particle size of the crystals can be measured using a Malvern zetasizer instrument following method ASTM E1037-84, version 1, 2004. The nanoclay particle size referred to herein is the z-average diameter, an intensity mean size. Nanoclays can be from natural or synthetic sources. Suitable nanoclays for use herein may have a particle size (z-average diameter) of from about 10 nm to about 300 nm, from about 20 nm to about 100 nm or even form about 30 to about 90 nm. The layered clay minerals suitable for use in the present invention include those in the geological classes of the smectites, the kaolins, the illites, the chlorites, the attapulgites and the mixed layer clays. Smectites, for example, include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. Illites include bravaisite, muscovite, paragonite, phlogopite and biotite. Chlorites include corrensite, penninite, donbassite, sudoite, pennine and clinochlore. Attapulgites include sepiolite and polygorskyte. Mixed layer clays include allevardite and vermiculitebiotite.

In one aspect of the present invention, nanoclays including natural or synthetic hectorites, montmorillonites and bentonites may be employed. In one aspect of the present invention synthetic hectorites clays may be employed. Typical sources of commercial hectorites include the LAPONITE range from Rockwood Additives Limited Princeton, New Jersey, USA, or Southern Clay Products, Inc., Texas, USA.; Veegum Pro and Veegum F from R. T. Vanderbilt, Company Inc, Norwalk, Conn., U.S.A.; and the Barasyms, Macaloids and Propaloids from Baroid Division, National Read Company, Oklahoma, USA. Synthetic hectorite is commercially marketed under the trade name LAPONITE by Rockwood Additives Limited Princeton, New Jersey, USA and Southern Clay Products, Inc., Texas, USA. There are many grades or variants and isomorphous substitutions of LAPONITE marketed. Examples of commercial hectorites are Lucentite SWN, LAPONITE S, LAPONITE XLS, LAPONITE RD and LAPONITE RDS. In one aspect of the present invention, Laponite RD may be employed.

The ratio of the largest dimension of a particle to the smallest dimension of a particle is known as the particle's aspect ratio. The aspect ratio of the particles in a dispersed medium can be considered to be lower where several of the particles are aggregated than in the case of individual particles. The aspect ratio of dispersions can be adequately characterized by TEM (transmission electron microscopy). A high aspect ratio is desirable for the nanoclay for use herein. In one aspect, the aspect ratio of the nanoclay in the cleaning composition is from 5 to about 35, or even from about 10 to about 20.

In one aspect of the present invention, the cleaning composition further comprises a dispersant. While not being bound by theory, it is believed that the dispersant helps to keep the nanoparticle exfoliated, especially under hard water conditions (hardness level greater than about 200 ppm (as CaCO₃)). In one aspect of the present invention, the nanoclay and the dispersant may have a weight ratio of from about 1:1 to about 1:10, or even from about 1:2 to about 1:8. Flocculation or aggregation may occur outside these ranges.

Suitable dispersants for use herein include:
(a) low molecular weight polyacrylate homopolymer, having a weight average molecular weight of from about 1,000 Da to about 30,000 Da, from about 2,000 Da to about 20,000 Da or even from about 3,000 Da to about 12,000 Da;
(b) environmentally friendly sequesterants, in particular MGDA (methyl glycine di-acetic acid) and GLDA (glutamic acid-N,N-diacetate);
(c) mixtures thereof.

Foaming nonionic surfactants—Suitable foaming nonionic surfactants include linear or branced alcohol alkoxylates, such as the nonionic surfactants sold under the tradenames Lutensol XL60, Lutensol XL70, Lutensol XL90, sold by the BASF Corporation, Ludwigshafen, Germany.

Solvents—Suitable solvents include water, alcohols, glycols, polyols and other solvents, such as lipophilic fluids. In one aspect of the present invention, suitable solvents include water, ethanol, propylene glycol, dipropylene glycol, other environmentally-friendly solvents and mixtures thereof.

Water Soluble Film—In aspect of the present invention, the cleaning compositions of the present invention may be in the form of a water-soluble pouch. In one aspect, a multi-phase unit dose pouch, such as an injection-moulded, vacuum- or thermoformed multi-compartment. Suitable manufacturing methods for unit dose executions are described in WO 02/42408 and EP 1,447,343 B1. Any water-soluble film-forming polymer which is compatible with the cleaning compositions of the present invention and which allows the delivery of the cleaning composition into the main-wash cycle of a dishwasher can be used as enveloping material. In one aspect, film materials may be selected from polyvinyl alcohols, polyvinyl pyrrolidone, polyalkylene oxides, cellulose, cellulose ethers, cellulose esters, cellulose amides, polyvinyl acetates, polyamides, polyacrylamide. In one aspect, film materials may be selected from polyamides, polymethacrylates, polyvinyl alcohols, polyvinyl alcohol copolymers, hydroxypropyl methyl cellulose (HPMC), and mixtures thereof. In one aspect, the film material comprises a polyvinyl alcohol (PVA).

Suitable pouch materials include PVA films known under the trade reference Monosol M8630, as sold by Chris-Craft Industrial Products of Gary, Indiana, US, and PVA films of corresponding solubility and deformability characteristics. Other films suitable for use herein include films known under the trade reference PT film or the K-series of films supplied by Aicello, Chemical Co Ltd, Toyohashi, Aichi, Japan, or VF-HP film supplied by Kuraray Co Ltd, Chiyoda-ku, Tokyo.

Without wishing to be bound by theory, it is believed that when a for unit dose formulation comprises a liquid phase, said liquid phase should comprise a sufficient amount of water to prevent film cracking (too low a water content) but not so much water that the film dissolves. In one aspect, said liquid phase of the cleaning composition may comprise, based on total liquid phase weight, from about 1 wt. % to about 90 wt. %, from about 2 wt. % to about 70 wt. %, from about 2 wt. % to about 10 wt. % or even from about 5 wt. % to about 8 wt. % water.

### Processes of Making and Using Compositions

The compositions of the present invention can be formulated into any suitable form and prepared by any process chosen by the formulator, non-limiting examples of which are described in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303.

### Method of Use

As will be appreciated by one skilled in the art, the cleaning compositions of the present invention are ideally suited for use in dishwashing applications. Accordingly, the present invention includes a method for washing kitchenware. The method comprises the steps of contacting kitchenware with a cleaning dishwashing solution. In one aspect, A method of using the cleaning compositions of the present invention, comprising contacting, in neat or diluted form, kitchen ware with one or more of said cleaning composition and before, during and/or after said contacting process, optionally rinsing and/or washing said kitchen ware is disclosed.

The solution may have a pH of from about 8 to about 10.5. The compositions may be employed at concentrations of from about 2000 ppm to about 20,000 ppm in solution. The water temperatures typically range from about 40° C. to about 70° C.

### Test Methods

It is understood that the test methods that are disclosed in the Test Methods Section of the present application should be used to determine the respective values of the parameters of Applicants' invention as such invention is described and claimed herein.

### K_{I} Determination

Determination of K_{I}: The inhibition constant K_{I} may be determined by using standard methods, for reference see Keller et al, Biochem. Biophys. Res. Com. 176, 1991, pp.401-405; J. Bieth in Bayer-Symposium “Proteinase Inhibitors”, pp. 463-469, Springer-Verlag, 1974 and Lone Kierstein Hansen in “Determination of Specific Activities of Selected Detergent Proteases using Protease Activity, Molecular Weights, Kinetic Parameters and Inhibition Kinetics”, PhD-report, Novo Nordisk A/S and University of Copenhagen, 1991 and U.S. Pat. No. 5,972,873 which is incorporated herein by reference.

The inhibition constant K_{I} for Savinase™ can be determined as described in U.S. Pat. No. 5,972,873 using standard methods under the following conditions:
Substrate: Succinyl-Alanine-Alanine-Proline-Phenylalanine-para-nitro-anilide=SAAPFpNA (Sigma S-7388).
Buffer: 0.1M Tris-HCl pH 8.6; 25° C.
Enzyme concentration in assay:
Protease used is Savinase® available from Novozymes AIS: 1×10⁻¹⁰ −3×10⁻¹⁰ M

The initial rate of substrate hydrolysis is determined at nine substrate concentrations in the range of 0.01 to 2 mM using a Cobas Fara automated spectrophotometer. The kinetic parameters Vₘₐₓ and Kₘ are determined using ENZFITTER (a non-linear regression data analysis program). k_{cat} was calculated from the equation Vₘₐₓ=k_{cat}×[Eₒ]. The concentration of active enzyme [Eₒ] was determined by active site titration using tight-binding protein proteinase inhibitors. The inhibition constant K_{I} was calculated from plots of Kₘ/k_{cat} as a function of the concentration of inhibitor. The inhibitors are assumed to be 100% pure and the molar concentrations are determined using weighing numbers and molecular weights.

pH

pH is assayed according to the standard method ES ISO 10523:2001 version 1.

### Viscosity Method

Viscosity is determined using a viscometer (Model AR2000, available from TA Instruments, New Castle, Del., USA), each sample is tested at a sample temperature of 25° C. using a 40 mm 2° steel cone at shear rates between 0.01 and 150 s⁻¹. Viscosities are expressed as units centipoise (cps) and are measured at a shear rate of 1 s⁻¹.

### Average Particle Size

Average Particle Size is determined in accordance ASTM E1037-84 version 1, 2004

### Ross Miles Foam Height

Ross Miles Foam Height is determined in accordance with method DIN 53902-2, 1977 using the following conditions; foam height (mm) of a 0.1% by weight aqueous solution measured after 5 minutes, at a temperature of 24° C.±1° C.

### Draves Wetting Time

Draves Wetting Time is determined in accordance with method ISO 8022: 1990, using the following conditions; 3-g hook, 5-g cotton skein, 0.1% by weight aqueous solution at a temperature of 25° C.

### EXAMPLES

Unless otherwise indicated, materials can be obtained from Aldrich, P.O. Box 2060, Milwaukee, Wis. 53201, USA.

### Example 1

### Synthesis of Encapsulated Protease

In one example, Savinase aqueous preparation supplied by Novozymes A/S having proteolytic activity of 44 KNPU/g (777 g) is mixed with 45% polyvinyl pyrrolidone K60 solution (190 g) and 32.4 g of diethylene triamine (DETA) added to this mixture.

An oil phase is prepared by mixing 221 g of 21% emulsion stabiliser with 208 g of an isoparaffin, volatile hydrocarbon solvent, selected from the Isopar range of volatile hydrocarbons sold by ExxonMobil, Houston, Tex., USA.

The aqueous enzyme mixture containing the DETA is added to the above oil phase and homogenised with a high shear Silverson mixer to form a water-in-oil emulsion having a mean droplet size of about 3 μm. The temperature of the emulsion is kept below 40° C. during this step. After formation of the emulsion, an extra 571 g of the volatile solvent is added to dilute the W/O emulsion.

The resulting emulsion is placed under mechanical stirring and warmed to 37° C. An oil-monomer phase is prepared by dissolving 34 g of terephthaloyl chloride (TPC) in 966 g of the volatile solvent. This oil-monomer phase is added to the warm emulsion over 5 minutes to initiate the wall forming reaction. A polyamide membrane forms around the fine aqueous enzyme droplets. The reaction mixture is left stirring for 30 minutes to complete the interfacial polymerisation.

The resultant suspension has a dispersed phase which accounted for about 33% of the total weight of the suspension.

This suspension is then dehydrated by distillation and subjected to a solvent exchange process with non-ionic surfactant substantially as described in Example 1 of WO 94/25560 to provide a substantially stable dispersion in non-ionic surfactant of particles having a mean size of about 3 μm. The suspension has approximately 40 KNPU/g proteolytic activity.

In this process, shell formation is satisfactory, and a stable monoparticulate dispersion is formed both initially and after the solvent exchange and when added to detergent concentrate when the stabiliser is any of the following copolymers.:

A styrene/octadecyl methacrylate/methacrylic acid copolymer in the weight ratio of 30/30/40.

Octadecyl methacrylate/methacrylic acid 66/34.

Octadecyl methacrylate/methyl methacrylate/acrylic acid 50/25/25.

Octadecyl methacrylate/methacrylic acid 64/36.

Octadecyl methacrylate/methyl methacrylate/acrylic acid/methacrylic acid 40/50/5/5.

Acrylonitrile/lauryl acrylate/acrylic acid 25/35/40.

Lauryl methacrylate/styrene/acrylic acid 40/50/10.

Styrene/docosaryl acrylate/methacrylic acid 55/35/10.

Octadecyl methacrylate/vinyl acetate/methyl methacrylate/methacrylic acid 35/10/45/10.

The resultant dispersion in non-ionic surfactant can then be blended with other components of a conventional liquid detergent concentrate thereby introducing into the detergent both the non-ionic surfactant and the particles containing enzyme. Further details of this preparation described in U.S. Pat. No. 6,242,405 B1.

### Examples 2-3

### ADW Dual Phase Pouch

### Pouch Making Process:

The cleaning composition of Table 1 is introduced in a two compartment layered PVA rectangular base pouch. The dual compartment pouch is made from a Monosol M8630 film as supplied by Chris-Craft Industrial Products. 17.2 g of the particulate composition and 4 g of the liquid composition are placed in the two different compartments of the pouch. The pouch dimensions under 2 Kg load are: length 3.7 cm, width 3.4 cm and height 1.5 cm. The longitudinal/transverse aspect ratio is thus 1.5:3.2 or 1:2.47. The pouch is manufactured using a two-endless surface process, both surfaces moving in continuous horizontal rectilinear motion. According to this process a first web of pouches is prepared by forming and filling a first moving web of open pouches mounted on the first endless surface and closing the first web of open pouches with the second web of filled and sealed pouches moving in synchronism therewith.

TABLE 1

| | 2 | 3 |
|---|---|---|
| | (wt %) | (wt %) |
| Particulate composition | | |
| Tetradecyl dimethylamine oxide | 5 | 0 |
| SLF-18 Poly-Tergent | 5 | 1.5 |
| Hydroxyethane di phosphonate (HEDP) (62.5% | 1 | 0.4 |
| active) | | |
| Termamyl ® (21.55 mg active/g) | 1.5 | 0.3 |
| FN3 ® (123 mg active/g) | 2 | 0 |
| Sodium Percarbonate | 15 | 3.0 |
| Penta Amine Acetato-cobalt(III) nitrate (1% active) | 0 | 0.5 |
| Sodium Carbonate | 9 | 45 |
| Silicate 2R (SiO₂:Na₂O at ratio 2:1) (48% active) | 6 | 0 |
| Sodium Diisilicate (80% active) | 0 | 5.0 |
| Perfume | 0.5 | 0.5 |
| Methylglycine diacetic acid (83% active) | 0 | 14 |
| Alcosperse ™ 725 (36% active)⁶ | 0 | 2.0 |
| Adjuncts | Balance | Balance |
| | to 100% | to 100% |
| Liquid composition | | |
| FN3 liquid (48 mg active/g)⁴ | 3.0 | 0.0 |
| Peptide Aldehyde⁵ | 0.05 | 0.0 |
| Savinase Ultra XL (44 mg active/g)² | 0 | 6.0 |
| Sodium formate | 0 | 0.1 |
| Dye | 0.5 | 0.2 |
| Dipropylene Glycol & other adjuncts | Balance | Balance |
| | to 100% | to 100% |

### Examples 4-15

### Automatic Dishwashing Gels

TABLE 2

| | 4 | 5 | 6 | 7 | 8 |
|---|---|---|---|---|---|
| | (wt %) | (wt %) | (wt %) | (wt %) | (wt %) |
| Wetting agent¹ | 1.0 | 1.3 | 0.8 | 1 | 0.9 |
| Sodium Benzoate (33% active) | 0.61 | 0.61 | 0.61 | 0.6 | 0.6 |
| Xanthan gum | 1.0 | 0.8 | 1.2 | 1 | 1.1 |
| Sodium Sulphate | 10.0 | 10.0 | 10.0 | 8 | 10 |
| Perfume | 0.03 | 0.05 | 0.03 | 0.06 | 0.1 |
| Sodium Silicate | 0 | 0 | 0 | 0 | 2 |
| Citric Acid (50% active) | 12.5 | 14 | 11 | 12 | 12 |
| Savinase Ultra XL(44 mg active/g)² | 0.7 | 0 | 0.3 | 0 | 0 |
| 4-Formyl-Phenyl Boronic Acid | 0 | 0 | 0.05 | 0 | 0 |
| Encapsulated Protease (10 mg/g)³ | 0.0 | 2.0 | 0.0 | 0 | 0 |
| FN3 liquid (48 mg active/g)⁴ | 0.0 | 0.0 | 0 | 0.6 | 0 |
| Protease Prill (123 mg active/g)⁴ | 0 | 0 | 0 | 0 | 0.5 |
| Peptide Aldehyde⁵ | 0.0 | 0.0 | 0 | 0.0025 | 0 |
| Ethanol | 0.0 | 0.0 | 0 | 0.3 | 0 |
| Potassium Hydroxide (45% active) | 14.6 | 14.6 | 14.6 | 14 | 0 |
| Calcium Chloride (25% active) | 1.8 | 1.8 | 1.8 | 1.1 | 0.4 |
| Dye | 0.05 | 0.05 | 0.05 | 0.05 | 0.02 |
| Proxcel GXL ™ (19% active)⁸ | 0.05 | 0.05 | 0.05 | 0.05 | 0.05 |
| Acusol ™ 820⁹ | 0.34 | 0.34 | 0.3 | 0.35 | 0.3 |
| Acusol ™ 425N (50% active)⁹ | 3.0 | 3.0 | 3.5 | 2.5 | 2 |
| Termamyl Ultra ® (25 mg/g active)² | 0.2 | 0 | 0 | 0 | 0.1 |
| Stainzyme Plus ® (12 mg/g active)² | 0 | 0.3 | 0.2 | 0 | 0.2 |
| Natalase ® (29 mg/g active)² | 0 | 0 | 0 | 0.2 | 0 |
| Water & other adjunct ingredients | Balance to | Balance | Balance | Balance | Balance to |
| | 100% | to 100% | to 100% | to 100% | 100% |

TABLE 3

| | 9 | 10 | 11 | 12 | 13 | 14 | 15 |
|---|---|---|---|---|---|---|---|
| | (wt %) | (wt %) | (wt %) | (wt %) | (wt %) | (wt %) | (wt %) |
| Wetting agent¹ | 1.0 | 1.3 | 1.2 | 0.8 | 0.9 | 1 | 1 |
| Sodium Benzoate | 0.2 | 0.2 | 0.3 | 0.1 | 0.2 | 0.2 | 0.2 |
| Xanthan gum | 0.8 | 0.8 | 1 | 1 | 0.7 | 0.8 | 0.8 |
| Perfume | 0.1 | 0.12 | 0.07 | 0.1 | 0.1 | 0.1 | 0.08 |
| Sodium Silicate | 1.8 | 2 | 2.5 | 1.4 | 3 | 1.8 | 1.5 |
| Methylglycine diacetic acid | 5 | 6 | 4 | 5 | 5 | 0 | 0 |
| Acrylic maleic co-polymer⁷ | 7.5 | 8 | 8 | 6 | 7 | 7.5 | 6 |
| Glutamic-N,N-diacetic | 0 | 0 | 0 | 0 | 0 | 5 | 6 |
| acid | | | | | | | |
| Savinase Ultra XL(44 mg | 0.8 | 0 | 0.6 | 0 | 0 | 1 | 0 |
| active/g)² | | | | | | | |
| 4-Formyl-Phenyl Boronic | 0 | 0 | 0.05 | 0 | 0 | 0 | 0 |
| Acid | | | | | | | |
| Encapsulated Protease | 0.0 | 1.4 | 0.0 | 0 | 0 | 0 | 0 |
| (20 mg/g)³ | | | | | | | |
| FN3 liquid (48 mg active/g)⁴ | 0.0 | 0.0 | 0 | 0.6 | 0 | 0 | 0 |
| Protease Prill (123 mg | 0 | 0 | 0 | 0 | 0.5 | 0 | 0.6 |
| active/g)⁴ | | | | | | | |
| Peptide Aldehyde⁵ | 0.0 | 0.0 | 0 | 0.0025 | 0 | 0 | 0 |
| Ethanol | 0.0 | 0.0 | 0 | 0.3 | 0 | 0 | 0 |
| Calcium Chloride | 0.45 | 0.4 | 0.5 | 0.3 | 0.6 | 0.45 | 0.45 |
| Dye (7% active) | 0.05 | 0.05 | 0.05 | 0.05 | 0.02 | 0.05 | 0.04 |
| Proxcel GXL⁸ | 0.01 | 0.01 | 0.01 | 0.01 | 0.01 | 0.01 | 0.01 |
| Acusol ™ 425N (50% | 0 | 3 | 0 | 1.5 | 2 | 0 | 1 |
| active)⁶ | | | | | | | |
| bis((C₂H₅O)(C₂H₄O)ₙ)(CH₃)—N+—CₓH₂ₓ—N+—(CH₃)- | 2 | 1.5 | 1.7 | 2 | 2 | 0 | 1 |
| bis((C₂H₅O)(C₂H₄O)ₙ) | | | | | | | |
| Termamyl Ultra ® (25 mg/g | 0.2 | 0 | 0 | 0 | 0.1 | 0 | 0.1 |
| active)² | | | | | | | |
| Stainzyme Plus ® (12 mg/g | 0 | 0.3 | 0.2 | 0 | 0.2 | 0 | 0.4 |
| active)² | | | | | | | |
| Natalase ® (29 mg/g active)² | 0 | 0 | 0 | 0.2 | 0 | 0.2 | 0 |
| Water & other adjunct | Balance | Balance | Balance | Balance | Balance | Balance | Balance |
| ingredients | to 100% | to | to | to | to 100% | to | to 100% |
| | | 100% | 100% | 100% | | 100% | |

¹Sold under tradename Polytergent ® SLF-18 by BASF, Ludwigshafen, Germany.
²Sold by Novozymes A/S, Denmark.
³Encapsulated protease of this invention
⁴Sold by Genencor International, California, USA. Suitable protease prills are sold under the tradenames FN3 ® and Properase ®.
⁵Peptide aldehyde of this invention.
⁶Sold by Alco Chemical, Tennessee, USA.
⁷One such suitable polymer would be sold under the tradename Aqualic TL by Nippon Shokubai, Japan.
⁸Sold by Arch Chemicals Incorporated, Smyrna, Georgia, USA
⁹Sold by Rohm and Haas, Philadelphia, Pennsylvania, USA

### Raw Materials and Notes For Cleaning Composition Examples 2-15

2.0R Silicate is supplied by PQ Corporation, Malvern, Pa., USA.
Sodium Carbonate is supplied by Solvay, Houston, Tex., USA
Sodium percarbonate (2Na₂CO₃.3H₂O₂) supplied by Solvay, Houston, Tex., USA
Hydroxyethane di phosphonate (HEDP) is supplied by Dow Chemical, Midland, Mich., USA

The dimensions and values disclosed herein are not to be understood as being strictly limited to the exact numerical values recited. Instead, unless otherwise specified, each such dimension is intended to mean both the recited value and functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising:
a.) a protease cleaning system comprising a material selected from the group consisting of:
(i) a protease and a mass-efficient reversible protease inhibitor;
(ii) an encapsulated protease; and
(iii) mixtures thereof;
b.) a wetting agent;
c.) a solvent; and
d.) based on total cleaning composition weight, from 0% to about 0.1% phosphate and/or polyphosphate;
e.) based on total cleaning composition weight, from 0% to about 0.1% borate;
f.) based on total cleaning composition weight, from 0% to about 0.1% zeolite;
the balance of said composition comprising one or more adjunct ingredients, said cleaning composition having a viscosity of from about 10 cps to about 100,000 cps.

2. The cleaning composition of claim 1, comprising, based on total cleaning composition weight:
a.) from 0% to about 0.1% of a material that is not a wetting agent, said material selected from the group consisting of an anionic surfactant, a cationic surfactant, a foaming nonionic surfactant and mixtures thereof; and
b.) from 0% to about 5.0% of a low-wetting nonionic surfactant that is not a wetting agent.

3. The cleaning composition of claim 1, wherein said wetting agent comprises a material selected from the group consisting of:
a.) alkoxylated aliphatic alcohols, having a cloud point of less than about 60° C., and comprising an alkyl chain comprising from about 6 to about 24 carbon atoms and from about 2 to about 50 pendant alkylene oxide units;
b.) epoxy capped poly(oxyalkylated)alcohols; and
c.) mixtures thereof.

4. The cleaning composition of claim 1, said composition comprising, based on total cleaning composition weight:
a.) at least 0.00001% protease and at least 0.00001% mass-efficient reversible protease inhibitor; and/or at least 0.001% encapsulated protease; and
b.) at least 0.1% of said wetting agent.

5. The cleaning composition of claim 1, said composition having a viscosity of at least 500 cps.

6. The cleaning composition of claim 1 comprising a thickener, said thickener comprising, based on total thickener weight, at least 1% alcohol moieties.

7. The cleaning composition of claim 1 wherein:
a.) said protease is selected from the group consisting of a metalloprotease, a serine proteases and mixtures thereof; and
b.) said mass-efficient reversible protease inhibitor is selected from the group consisting of a peptide aldehyde, galardin, protein hydrolysates, a phenyl boronic acid derivative and mixtures thereof.

8. The cleaning composition of claim 7 wherein:
a.) said serine protease comprises an alkaline serine protease from E.C. class 3.4.21.62; and
b.) said phenyl boronic acid derivative comprises 4-formyl phenyl boronic acid.

9. The cleaning composition of claim 1 comprising one or more enzymes wherein the enzymes are selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, and mixtures thereof.

10. The cleaning composition of claim 1 having a pH of from about 6 to about 11.

11. The cleaning composition of claim 1 comprising, based on total cleaning composition weight, at least 0.1% of a nanoparticle composition.

12. The cleaning composition of claim 11, wherein said nanoparticle composition comprises nanoclays, selected from the group consisting of bentonites, hectorites and mixtures thereof.

13. The cleaning composition of claim 1 comprising, a polymer selected from the group consisting of:
a.) polycarboxylate-based polymers;
b.) sulphonate or sulphonic acid co-polymers;
c.) a polymer having the following formula:
bis ((C₂H₅O)(C₂H₄O)ₙ)(CH₃)—N+—CₓH₂ₓ—N+—(CH₃)-bis((C₂H₅O)(C₂H₄O)ₙ) wherein n is an integer from 20 to 30, and x is an integer from 3 to 8, said polymer optionally being sulphated or sulphonated;
d.) styrene-based co-polymers; and
e.) mixtures thereof.

14. The cleaning composition of claim 1 comprising an enzyme stabilizer component, said enzyme stabilizer component comprising:
a.) inorganic salts selected from the group consisting of calcium salts, magnesium salts and mixtures thereof;
b.) carbohydrates selected from the group consisting of oligosaccharides, polysaccharides and mixtures thereof; and
c.) mixtures thereof.

15. The cleaning composition of claim 1 comprising, based on total cleaning composition weight, from about 1% to about 30% by weight of an environmentally friendly sequesterant.

16. A cleaning composition of claim 1 comprising a metal care component comprising a material selected from the group consisting of a benzatriazole, a metal complex, a metal salt, silicates and mixtures thereof.

17. The cleaning composition of claim 17 wherein said metal care component comprises a material selected from the group consisting of a zinc salt, a tolytriazole, sodium metasilicate and mixtures thereof.

18. A method of using the cleaning composition of claim 1, comprising contacting, in neat or diluted form, kitchen ware with said cleaning composition and before, during and/or after said contacting process, optionally rinsing and/or washing said kitchen ware.

19. An article comprising the cleaning composition of claim 1 and a water soluble film.

20. The article of claim 19 that comprises a fluid cleaning composition according to claim 1 said fluid cleaning composition having a viscosity of from about 50 cps to about 1000 cps, said fluid cleaning composition comprising, based on total fluid cleaning composition weight, from about 1% to about 90% water.

21. A cleaning composition comprising a metalloprotease, a mass-efficient reversible protease inhibitor; and an adjunct ingredient.

22. The cleaning composition of claim 21, wherein the mass efficient reversible protease inhibitor is selected from the group consisting of galardin, phosphoramidon, bacitracin zinc and mixtures thereof.

23. The cleaning composition of claim 6 wherein said thickener comprises a polysaccharide and/or a polysaccharide derivative, said polysaccharide or a polysaccharide derivative comprising guar, gellan, xanthan gum and mixtures thereof.

24. The cleaning composition of claim 23 comprising, based on total cleaning composition weight, from about 0.5% to about 10% sodium silicate and xanthan gum, said xanthan gum being present in said cleaning composition at level such that the weight ratio of sodium silicate to xanthan gum is from about 15:1 to about 1:2.


SEQUENCE LISTING (2 sequences)

SEQ ID NO: 1 - protein, 269 aa, Bacillus Alkalophilus PB92
AQSVPWGISRVQAPAAHNRGLTGSGVKVAVLDTGISTHPDLNIRGGASFVPGEPSTQDGNGHGTHVAGTIAALNNSIGVLGVAPNAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 485 aa, Bacillus sp. 707
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGKQNDYLDHHNIIGWTREGNTAHPNSGLATIMSDGAGGSKWMFVGRNKAGQVWSDITGNRTGTVTINADGWGNFSVNGGSVSIWVNK